(19) United States
(12) Patent Application Publication
(10) Pub. No.: US 2016/0275506 A1
(43) Pub. Date: Sep. 22, 2016

(54) SYSTEM AND METHOD OF CONTACTLESS MOBILE PAYMENT VERIFICATION

(71) Applicant: CA, Inc., New York, NY (US)

(72) Inventors: Vishwanatha SALIAN, Ramamurthy Nagar (IN); Mahesh Malatesh CHITRAGAR, Ramamurthy Nagar (IN); Sharath Lakshman KUMAR, Basavanagudi (IN); Mohammed Mujeeb KALADGI, Kavalbyrasandra (IN)

(73) Assignee: CA, Inc.

(21) Appl. No.: 14/660,384

(22) Filed: Mar. 17, 2015

(51) Int. Cl. G06Q 20/40; G06Q 20/32

(52) U.S. Cl. CPC G06Q 20/405; G06Q 20/3227; G06Q 20/401

(57) ABSTRACT

A method for communicating payment status is described. The method comprises receiving an authorization request, via a local merchant terminal, at an issuer system. The authorization request may be generated during a contactless transaction. The authorization request is verified at the issuer system. The issuer system generates a first verification response and a second verification response. The issuer system transmits the first verification response directly to a payment module on a mobile device. The issuer also transmits the second verification response to the local merchant terminal.

### TECHNICAL FIELD

The present disclosure relates to contactless transactions and, in particular, to an apparatus, computer-readable medium, and method for generating payment confirmation in a contactless mobile payment.

### BACKGROUND

Consumers desire to complete efficient transactions with various merchants using credit cards. As mobile devices have grown in popularity, consumers now desire the ability to complete transactions with merchants using their mobile phones. Mobile phones can be used for making payments via a contactless transaction at a merchant terminal. However, during the contactless transaction, the merchant terminal does not communicate payment status to the mobile device. As notification of payment continues to trend towards paperless, consumers desire a means for electronic payment confirmation.

Europay, MasterCard, and Visa (“EMV”) sets a global standard that defines a suite of protocols employing strong cryptograph for the interoperation of EMV-enabled devices with EMV-capable merchant terminals and automated teller machines for authenticating transactions. EMV specifications do not define how a mobile device can receive payment acknowledgement during a contactless transaction.

Accordingly, there is a need in the marketplace for a system designed to receive payment status during a contactless transaction. Furthermore, from an efficiency, security, and cost standpoint, the current disclosure provides an effective solution to this problem by using the existing cardholder messaging infrastructure of the issuer.

Embodiments of the present disclosure can address the above problems, and other problems, individually and collectively.

### SUMMARY

According to an embodiment of the present disclosure, a method comprising generating an authorization request, via a payment module, on a mobile device, transmitting the authorization request to an issuer system via a local merchant terminal for verification, receiving at the payment module, a first verification response directly from the issuer system, determining, via the payment module, a transaction status from the first verification response, and displaying via the payment module, the transaction status based on the first verification response.

According to another embodiment of the present disclosure, a method comprising receiving at an issuer system, an authorization request from a local merchant terminal, verifying, at the issuer system, the authorization request, generating, at the issuer system, a first verification response and a second verification response, transmitting the first verification response from the issuer system directly to a payment module on a mobile device, and transmitting the second verification response from the issuer system to the local merchant terminal.

Other objects, features, and advantages will be apparent to persons of ordinary skill in the art in view of the following detailed description and the accompanying drawings.

### BRIEF DESCRIPTION OF THE DRAWINGS

For a more complete understanding of the present disclosure, needs satisfied thereby, and the objects, features, and advantages thereof, reference now is made to the following description taken in connection with the accompanying drawings. Embodiments of the present disclosure, and their features and advantages, may be understood by referring to FIGS. 1-4, like numerals being used for corresponding parts in the various drawings.

FIG. 1 illustrates a block diagram of the payment ecosystem in accordance with a non-limiting embodiment of the present disclosure.

FIG. 2 illustrates a flow diagram depicting a method of receiving confirmation during a contactless transaction in accordance with a non-limiting embodiment of the present disclosure.

FIG. 3 illustrates a schematic representation of a system infrastructure in accordance with a non-limiting embodiment of the present disclosure.

FIG. 4 illustrates yet another diagram of system infrastructure in accordance with a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

While certain example systems and methods disclosed herein may be described with reference to contactless transactions using a mobile device, systems and methods disclosed herein may also be related to contactless transactions utilizing credit cards, ticket scanning, transportation passes, and building access.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In the last fifty years, credit cards have become an immensely popular method of payment for goods and services. This is due in large part to the advantages credit cards provide to both the cardholder and the merchant. For example, credit cards often have magnetic strips that can contain a variety of information such as a cardholder's identity and account information. In addition, for example, credit cards offer cardholders and merchants the convenience of not having to carry or maintain large amounts of cash. Cardholders are also able to defer payment of a credit balance and purchase goods/services online securely using encrypted information.

More recently, in view of the recent expansion in mobile phone technology, the ability to use mobile phones to make contactless payments for goods and services has been an area of particular interest. There are basically two ways of conducting contactless mobile payments today that do not involve any cards or the swiping of such cards: Near Field Communications (“NFC”) based payments and Quick Response (“QR”) based payments. In NFC based transactions, a NFC-enabled device is capable of establishing wireless communication with another NFC-enable device by being brought into proximity with, without being touched to, the other device (e.g., the ability to tap a mobile device to a checkout terminal and the transaction is complete). In QR based transactions, a two-dimensional barcode, or matrix barcode, contains information about a transaction that can be read (i.e., processed) by a QR-code reading machine. For example, a QR code can be generated by a merchant, and a customer can use a mobile device and scan the QR code to complete the transaction; alternatively, the customer can generate a QR code, and the checkout terminal can scan the QR code to complete the transaction.

With regard to NFC-enabled devices being used in contactless payment methods, NFC-based payments can provide a more secure payment method compared with QR-based payments because NFC-based payments works on Europay, Mastercard and Visa (“EMV”) technologies, which is a global standard that defines a suite of protocols employing strong cryptograph for the interoperation of EMV-enabled cards with EMV-capable point of sale (“POS”) terminals and automated teller machines (“ATMs”) for authenticating transactions.

When a mobile device is used for making payments, either through NFC or QR based payments, all card data (e.g., card number, expiration data, billing address, and other relevant data) is encrypted and stored on the mobile device. A key used to encrypt the card data may be either camouflaged using CA ArcotID technology (found, for example, on www.ca.com), a key derived from a pin known to the user, or stored in a secure element of the mobile device. In addition, an account unique key (“AUKey”) used to generated a dynamic CVV is stored either in a secure element of the mobile device, or camouflaged using CA ArcotID technology. In particular, a dynamic CVV is generated based on the AUkey, an unpredictable number, a card number, and an application transaction counter (“ATC”). The unpredictable number may be provided by the POS, by the issuer (e.g., the issuer of the credit card), or prefetched in a batch. For example, when the unpredictable number is provided by the issuer, the issuer can verify the dynamic CVV against the unpredictable number (which was sent by the issuer itself). The ATC is a counter maintained by a chip card application that provides a sequential reference to each transaction for fraud monitoring purposes. For example, a duplicate ATC, a decrease in ATC, or a large jump in ATC values may indicate data copying or other fraudulent activities on the card. In addition, for security purposes, the counter number is incremented by one, via the ATC, after each transaction, and the incremented counter number is stored in a memory (e.g., a memory 12 of the mobile device 10).

In a typical NFC based payment, the mobile device is capable of connecting to the network (e.g., via the internet) to obtain the unpredictable number from the POS in order to generate a dynamic CVV to complete a transaction. However, in QR based payment methods which typically do not have access to the network, the unpredictable number cannot “travel” from the POS to the mobile device. According to an embodiment of the current disclosure, a cardholder initiates a transaction at a merchant terminal. The transaction can be a NFC transaction, a QR code transaction, or any other suitable type of transaction. The transaction can be contactless and can be initiated via a mobile device 10 such as, for example, a mobile phone. According to an embodiment of the current disclosure, the contactless transaction can be completed while the mobile device 10 is in an offline mode and not connected to the internet.

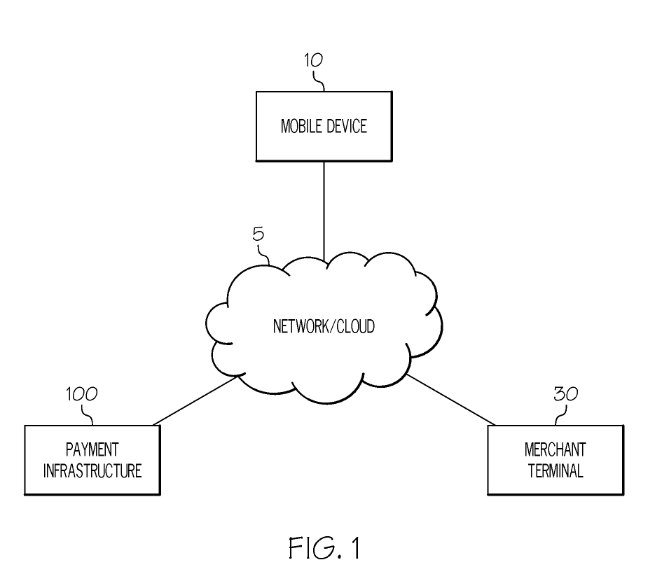

FIG. 1 illustrates a block diagram of the payment ecosystem in accordance with a non-limiting embodiment of the present disclosure. The payment ecosystem can include a mobile device 10, a payment infrastructure 100, a merchant terminal 30, each of which can be connected to a network/cloud 5. The merchant terminal 30 may be local, online, or any other suitable configuration. For example, a local merchant terminal is considered in close proximity to a mobile device such that the user can perform a contactless transaction. Network/cloud 5 may comprises one or more entities, which may be public, private, or community based. Each network/cloud 5 may permit the exchange of information and services among users/entities that are connected to such network/cloud 5. In certain configurations, network/cloud 5 may be a local area network, such as an intranet. Further, network/cloud 5 may be a closed, private network/cloud, in certain configurations, and an open network/cloud in other configurations. Network/cloud 5 may facilitate wired or wireless communications of information and provisioning of services among users that are connected to network/cloud 5.

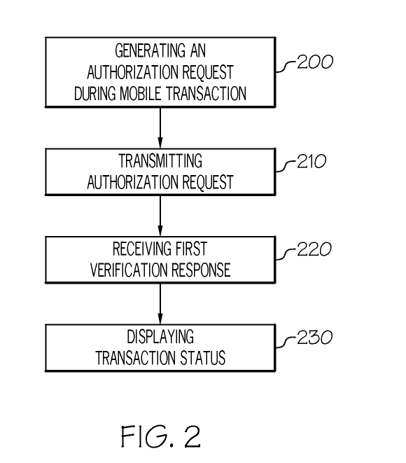

FIG. 2 illustrates a flow diagram depicting a method of receiving confirmation during a contactless transaction in accordance with a non-limiting embodiment of the present disclosure. In step 200, a mobile device 10 such as, for example, a mobile phone, generates an authorization request 24 during a mobile transaction. As mentioned above, the mobile transaction can be an NFC transaction, a QR code transaction, or any other suitable transaction type. In step 210, the mobile device 10 transmits the authorization request to an issuer system 60. The authorization request 24 can be sent to the issuer system 60 via a merchant terminal 30, or any other intermediary, or any combination thereof. In step 220, the mobile device 10 receives a first verification response 62. The first verification response 62 is sent from the issuer system 60 directly to the mobile device 10. In step 230, the mobile device 10 displays the transaction status communicated in the first verification response 62.

The flowchart depicted in FIG. 2 illustrates the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

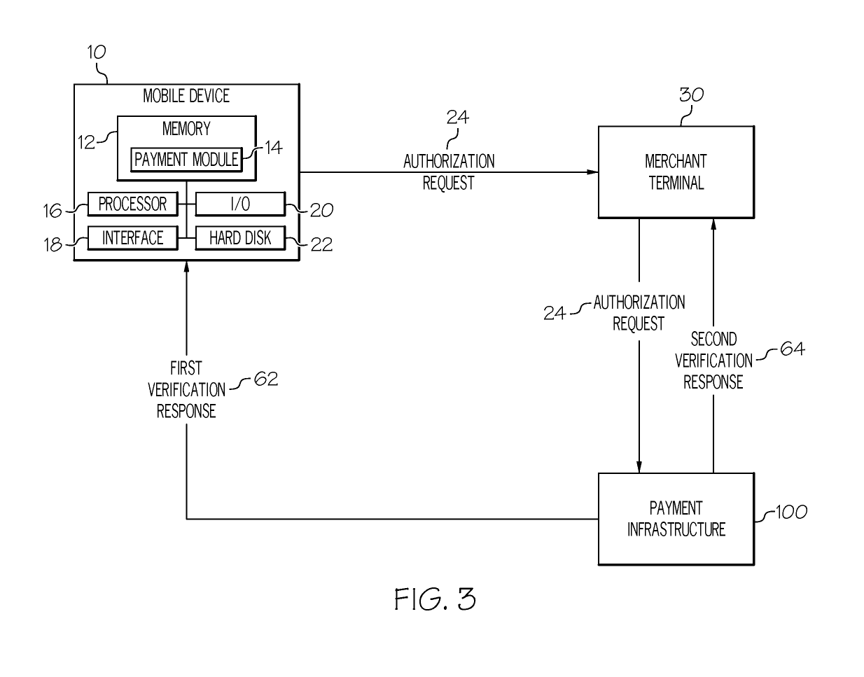

FIG. 3 illustrates the interaction between a mobile device 10, a merchant terminal 30, and a payment infrastructure 100 in accordance with a non-limiting embodiment of the present disclosure. FIG. 3 also depicts a mobile device 10, which may comprise a memory 12, a payment module 14, processor 16, interface 18, an input and output (“I/O”) device 20, and a hard disk 22. Processor 16 may be operable to load instructions from hard disk 22 into memory 12 and execute those instructions. Memory 12 may store computer-readable instructions that may instruct the mobile device 10 to perform certain processes. I/O device 20 may receive one or more of data from network/cloud 5, from payment infrastructure 100, from issuer 60, and from merchant terminal 30. The mobile device 10 can be NFC-enabled via antenna.

The payment module 14 can act as the interface for a cardholder during a contactless transaction. For example, the payment module 14 on the mobile device 10 may act as a control center for the cardholder during a contactless transaction; the payment module 14 may be the means with which the cardholder prepares the mobile device 10 for contactless transaction and the means with which the cardholder receives a display of payment confirmation. According to an embodiment of the current disclosure, the payment module 14 can be a mobile application installed on the mobile device 10.

The payment module 14 may generate an authorization request 24 and transmit the authorization request 24 to a merchant terminal 30 during a contactless transaction. In order to generate an authorization request 24, the payment module 14 may have additional security measures such as, for example, scanning a fingerprint, entering a passcode, or secure element authorization. The secure element can be a chip in a mobile device 10 or function virtually in the network/cloud 5.

The authorization request 24 may then be transmitted from the merchant terminal 30 to the payment infrastructure 100. The payment infrastructure can then process the authorization request 24, and subsequently transmit a first verification response 62 and a second verification response 64. The first verification response 62 can be sent to the payment module 14 on the mobile device 10. The payment module can process the first verification response 62 in order to display a transaction status to the user of the mobile device 10. The second verification response 64 can be sent to the merchant terminal 30 to notify the merchant terminal 30 of the transaction status. The first verification response 62 and second verification response 64 may be sent simultaneously, or in a staggered manner.

The merchant terminal 30 may be active or passive. If the merchant terminal 30 is active, it is powered by electricity or another power source. If the merchant terminal 30 is passive, it does not require any electricity or power source, but can still communicate with a contactless enabled device by, for example, NFC electromagnetic induction. In addition, the merchant terminal 30 may also be a mobile device, a tablet, a computer system, a smartphone-based system, any other suitable receiving system, or any combination thereof.

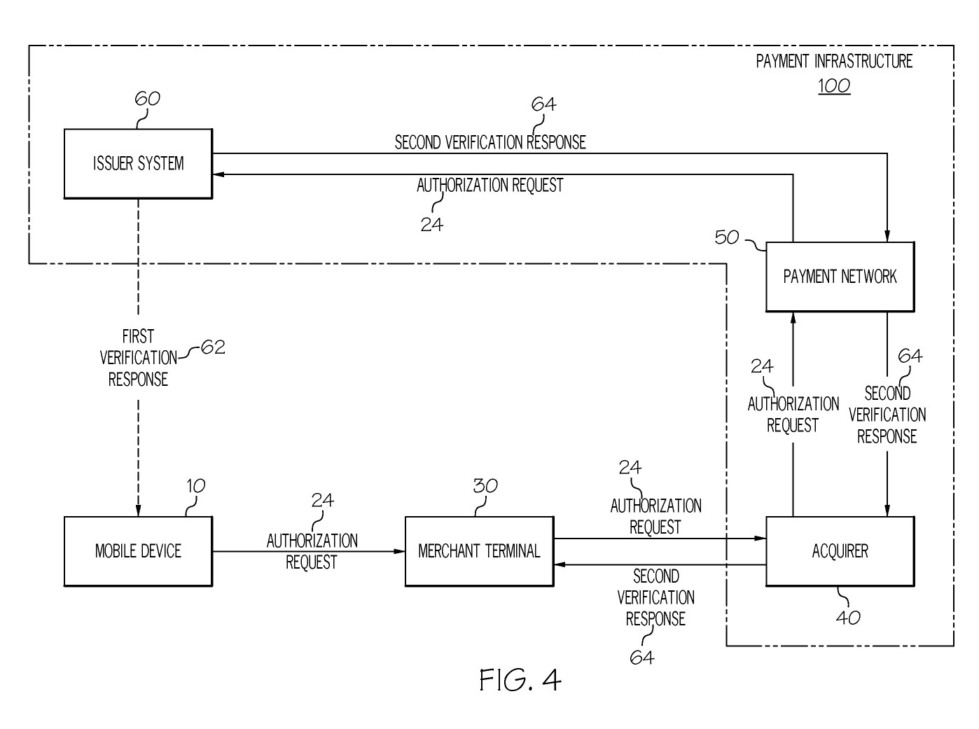

FIG. 4 illustrates yet another diagram of system infrastructure in accordance with a non-limiting embodiment of the present disclosure. FIG. 4 depicts the payment infrastructure 100. The payment infrastructure 100 can include an acquirer 40, a payment network 50, and an issuer system 60. The mobile device 10, during a contactless transaction, generates an authorization request 24 and transmits the authorization request 24 to a merchant terminal 30. The merchant terminal can transmit the authorization request 24 to an acquirer 40, which forwards the request to a payment network 50, which forwards the request to an issuer system 60. The issuer system 60 processes the authorization request 24 to determine a transaction status. Processing the authorization request 24 may include decrypting a cryptogram or deciphering a code for security purposes. The issuer system 60 subsequently transmits a first verification response 62 directly to the mobile device 10. The payment module 14 (FIG. 3) of the mobile device 10 may retrieve the first verification response 62 and display payment status to the user. The issuer system 60 also transmits a second verification response 64 to the payment network 50, which forwards the second verification response 64 to the acquirer 40, which then sends the second verification response to the merchant terminal 30. The second verification response 64 can also be sent from the issuer system 60 directly to the merchant terminal 30.

The authorization request 24 can be in the form of a cryptogram. The cryptogram can be in the form of a one-time password generated by Arcot OTP technology of CA Technologies. The issuer system 60 can also decrypt the cryptogram using Arcot OTP technology in order to determine a transaction status. Furthermore, the first and second verification responses 62, 64 may be in the form of a cryptogram or coded communication. Additionally, the first and second verification responses 62, 64 may also be in the form of short message service (“SMS”), email, or any other suitable type of communication.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

While the present disclosure has been described in connection with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. It will also be understood by those of ordinary skill in the art that the scope of the disclosure is not limited to use in transactions with a merchant terminal, but rather that embodiments of the invention may be used in any transaction having a need to receive confirmation notification of any type. The specification and the described examples are considered as exemplary only, with the true scope and spirit of the invention indicated by the following claims.

What is claimed is:

1. A method comprising:
receiving, at an issuer system, an authorization request from a local merchant terminal;
verifying, at the issuer system, the authorization request;
generating, at the issuer system, a first verification response and a second verification response;
transmitting the first verification response from the issuer system directly to a payment module on a mobile device; and
transmitting the second verification response from the issuer system to the local merchant terminal.

2. The method of claim 1, wherein the authorization request originated from the payment module on the mobile device.

3. The method of claim 1, wherein the authorization request results from a contactless transaction between the mobile device and the local merchant terminal.

4. The method of claim 3, wherein the contactless transaction is a near field communication transaction.

5. The method of claim 3, wherein the contactless transaction is a quick response code transaction.

6. The method of claim 1, wherein verifying the authorization request comprises decrypting a cryptogram.

7. The method of claim 1, wherein transmitting the first verification response occurs practically simultaneously with transmitting the second verification response.

8. The method of claim 1, wherein transmitting the second verification response further comprises:
transmitting the second verification response from the issuer system to a payment network;
transmitting the second verification response from the payment network to an acquirer entity; and
transmitting the second verification response from the acquirer entity to the local merchant terminal.

9. A computer configured to access a storage device, the computer comprising:
a processor; and
a non-transitory, computer-readable storage medium storing computer-readable instructions that when executed by the processor cause the computer to perform:
receiving, at an issuer system, an authorization request from a local merchant terminal;
verifying, at the issuer system, the authorization request;
generating, at the issuer system, a first verification response and a second verification response;
transmitting the first verification response from the issuer system directly to a payment module on a mobile device; and
transmitting the second verification response from the issuer system to the local merchant terminal.

10. The computer of claim 9, wherein the authorization request originated from the payment module on the mobile device during a contactless transaction between the mobile device and the local merchant terminal.

11. The computer of claim 10, wherein the contactless transaction is a near field communication transaction.

12. The computer of claim 10, wherein the contactless transaction is a quick response code transaction.

13. The computer of claim 9, wherein verifying the authorization request comprises decrypting a cryptogram.

14. The computer of claim 9, wherein transmitting the first verification response occurs practically simultaneously with transmitting the second verification response.

15. The computer of claim 9, wherein transmitting the second verification response further comprises:
transmitting the second verification response from the issuer system to a payment network;
transmitting the second verification response from the payment network to an acquirer entity; and
transmitting the second verification response from the acquirer entity to the local merchant terminal.

16. A computer program product comprising:
a computer-readable storage medium having computer-readable program code embodied therewith, the computer-readable program code comprising:
computer-readable program code configured to receive, at an issuer system, an authorization request for a local merchant terminal;
computer-readable program code configured to verify, at the issuer system, the authorization response;
computer-readable program code configured to generate, at the issuer system, a first verification response and a second verification response;
computer-readable program code configured to transmit the first verification response from the issuer system directly to a payment module on a mobile device; and
computer-readable program code configured to transmit the second verification response from the issuer system to the local merchant terminal.

17. The computer program product of claim 16, wherein the authorization request originated from the payment module on the mobile device during a contactless transaction between the mobile device and the local merchant terminal.

18. The computer program product of claim 17, wherein the contactless transaction is a near field communication transaction.

19. The computer program product of claim 16, wherein the computer-readable program code configured to verify an authorization request further comprises:
computer-readable program code configured to decrypt a cryptogram.

20. The computer program product of claim 15, wherein the computer-readable program code configured to transmit the second verification response further comprises:
computer-readable program code configured to transmit the second verification response from the issuer system to a payment network;
computer-readable program code configured to transmit the second verification response from the payment network to an acquirer entity; and
computer-readable program code configured to transmit the second verification response from the acquirer entity to the local merchant terminal.
